(19) United States
(12) Patent Application Publication
(10) Pub. No.: US 2003/0016409 A1
(43) Pub. Date: Jan. 23, 2003

(54) Method and system for trunk side monitoring for optical switching applications

(76) Inventor: Jasvantrai C. Shah, Richardson, TX (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/912,029

(22) Filed: Jul. 23, 2001

(51) Int. Cl. H04B 10/08; H04B 10/12

(52) U.S. Cl. 359/110; 359/173

(57) ABSTRACT

An optical switching system (and methods) for switching one of a plurality of optical signals. The system has an optical cross-connect apparatus, e.g., MEMS based. The system has a control device coupled to the optical cross-connect apparatus. A multiplexing device is coupled to the optical cross-connect apparatus. A trunk-monitoring device is disposed before the multiplexing device. The trunk-monitoring device being coupled to at least a primary fiber and a back up fiber. The system has a fiber switch coupled between the multiplexing device and the trunk-monitoring device. The fiber switch is adapted to switch an optical signal from the primary fiber to the back up fiber.

### BACKGROUND OF THE INVENTION

This present invention generally relates to techniques for optical switching. More particularly, the present invention provides a method and system for monitoring and/or controlling communication signals. Merely by way of example, the invention is applied to a MEMS based switching system over a wide area network for long haul communications. But it would be recognized that the invention could also be applied to other types of switching such as wave guides, electro-optic devices, holographic switches, bubble switches, liquid crystal switches, and many others for applications including metropolitan, access, and other networks.

Over the past years, digital telephone has progressed with a desire for faster communication networks. In general, conventional analog voice telephone signals have been converted into digital signals. These signals can have transmission rates of 64,000 bits/second and greater in some applications. Other telephone circuits interleave these bit streams from 24 digitized phone lines into a single sequence of 1.5 Mbit/second, commonly called the T1 or DS1 rate. The T1 rate feeds into higher rates such as T2 and T3. A T4 may also be used. Single mode fiber optics has also been used at much higher speeds of data transfer. Here, optical switching networks have also been improved. An example of such optical switching standard is called the Synchronous Optical Network (SONET), which is a switching standard designed for telecommunications to use transmission capacity more efficiently than the conventional digital telephone hierarchy, which was noted above. SONET organizes data into 810-byte “frames” that include data on signal routing and designation as well as the signal itself. The frames can be switched individually without breaking the signal up into its components, but still require conventional switching devices.

Most of the conventional switching devices often require the need to convert optical signals from a first source into electric signals for switching such optical signals over a communication network. Once the electric signals have been switched, they are converted back into optical signals for transmission over the network. As merely an example, a product called Aurora 128™, made by Tellium, Inc. uses such electrical switching technique. Other systems have been developed by Lucent Technologies, Inc., Ciena Corporation, and other companies. Numerous limitations exist with such conventional electrical switching technique. For example, such electrical switching often requires a lot of complex electronic devices, which make the device expensive, and difficult to scale. Accordingly, techniques for switching optical signals using a purely optical technology have been proposed. Such technology can use a MEMS approach for switching optical signals. Such purely optical switching systems, since they eliminate conversion to electrical signals, are less complex, less costly, and more scalable to higher capacity than their electrical counterparts.

Another development in the optical networking has been the introduction of Dense Wavelength Division Multiplexing (DWDM) systems, such as for example OPTera Long Haul 1600 Optical Line System offered by Nortel Networks, Inc., which have enabled the Telecommunications Network Operators to put as many as 160 different optical wavelengths, each carrying 10 Gb/s, on a single strand of fiber. In such a network, when a fiber experiences an outage due, for example, to a cut or malfunctioning of an associated equipment, the associated very large amount of telecommunications traffic is disrupted until it can be restored on an alternate path. Such incidents of traffic disruptions can have a substantial economic impact.

From the above, it is seen that an improved way to monitor and control a fiber is highly desirable.

### SUMMARY OF THE INVENTION

According to the present invention, techniques including methods and systems for monitoring and controlling a fiber are provided. More particularly, the present invention provides a method and system for monitoring and/or controlling communication signals using an intelligent photonic switch. Merely by way of example, the invention is applied to a MEMS based switching system over a wide area network for long haul communications. But it would be recognized that the invention could also be applied to other types of switching such as wave-guides, electro-optic devices, holographic switches, bubble switches, liquid crystal switches, and many others for applications including metropolitan, access, and other networks.

In a specific embodiment, the present invention provides an optical switching system for switching one of a plurality of optical signals. The system has an optical cross-connect apparatus, e.g., MEMS based. The system has a control device coupled to the optical cross-connect apparatus. A multiplexing device is coupled to the optical cross-connect apparatus. A trunk-monitoring device is disposed before the multiplexing device. The trunk-monitoring device being coupled to at least a primary fiber and a back up fiber. The system has a fiber switch coupled between the multiplexing device and the trunk-monitoring device. The fiber switch is adapted to switch an optical signal from the primary fiber to the back up fiber.

In an alternative embodiment, the invention provides a method for monitoring and controlling optical signals through a long haul communication network. The method includes monitoring optical signals from a first fiber using a trunk-monitoring device. The trunk-monitoring device is disposed before a multiplexing device coupled to an input port of a switching system. The method also detects a defect in the optical signals using the trunk-monitoring device. The method determines if the defect is from a selected defect (e.g., fiber cut, signal degradation) being monitored. If the defect is a selected defect, the method initiates a process to switch the optical signals from the first fiber to a second fiber path comprising one or more fiber links interconnected by photonic switches. In one embodiment, the invention provides for pre selection of the second fiber path for any arbitrary first fiber link prior to detection of a fault on the first fiber link. In yet another embodiment of the invention, the second fiber path is determined after a qualifying fault has been detected on the first fiber link. In one embodiment of the invention, the second fiber or second fiber path is dedicated for restoration. In another embodiment of the invention, the second fiber or second fiber path is allowed to carry traffic signals, which are preempted for restoration of the first fiber or first fiber link.

In yet an alternative embodiment, the invention provides a method for monitoring and controlling optical signals through a long haul communication network. The method includes monitoring optical signals from a first fiber using a trunk-monitoring device. The trunk-monitoring device is disposed before a multiplexing device coupled to an input port of a switching system. The method also detects a defect in the optical signals using the trunk-monitoring device. The method determines if the defect is from a selected defect (e.g., fiber cut, signal degradation) being monitored. If the defect is a selected defect, the method initiates a process to switch the optical signals from the first fiber to a second fiber path comprising one or more fiber links interconnected by photonic switches. The method also determines an available path for the second path from a pool of fibers. The pool of fibers has a plurality of optical paths. The method selects one of the available paths for the second path; and transfers the optical signals from the first path to the second path.

In still a further alternative embodiment, the invention provides a method for monitoring and controlling optical signals through an optical communication network. The method monitors optical signals from a first optical path on a first fiber using a trunk monitoring device. The trunk monitoring device is disposed before a multiplexing device coupled to an input port of a switching system. The method detects a defect in the optical signals using the trunk monitoring device; and determines if the defect is from a selected defect being monitored. If the defect is a selected defect, the method initiates a process to switch the optical signals from the first path in the first fiber to a second path in a second fiber based upon predetermined selection criteria, such as service level. If the first optical path is for a first service level, the method suspends the process to switch the optical signals from the first path to the second path. If the first optical path is for a second service level, the method transfers the optical signals from the first path to the second path.

Many benefits are achieved by way of the present invention over conventional techniques. In a specific embodiment, the invention can be implemented using conventional technologies. The invention also provides an easy way of monitoring and controlling optical signals. The invention can be used to provide a fault tolerant system, which is important in large switching systems. A benefit of the invention is that it enables the intelligent photonic switch to detect fiber defects without resorting to first converting the optical signal to an electrical form. Another advantage of the invention is that it does not have to rely upon DWDM devices to inform the intelligent photonic switches of the existence of the fault on a fiber. Yet another advantage of the invention is that it makes possible realization of more efficient fiber topologies as back up for restoration. Depending upon the embodiment, one or more of these benefits may be achieved. These and other benefits will be described more throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is simplified diagram of an optical switching network according to an embodiment of the present invention;

FIGS. 1A and 1B are simplified diagrams of the present system in alternative deployment embodiments;

FIG. 2 is a detailed diagram of an optical switching system according to an embodiment of the present invention;

FIG. 3 is a more detailed diagram of an optical switching system according to an embodiment of the present invention;

FIG. 4 is a more detailed block diagram of an optical switching system according to an alternative embodiment of the present invention;

FIGS. 5, 6, and 7 are simplified diagrams of alternative systems according to embodiments of the present invention;

FIG. 8 is a simplified flow diagram of a method according to an embodiment of the present invention;

FIG. 9 is a more detailed diagram of the method of FIG. 8 according to an embodiment of the present invention;

FIG. 10 is a simplified flow diagram of an alternative method according to an embodiment of the present invention; and

FIG. 11 is a more detailed diagram of the method of FIG. 10 according to an embodiment of the present invention.

### DESCRIPTION OF THE SPECIFIC EMBODIMENTS

According to the present invention, techniques including methods and systems for optical switching are provided. More particularly, the present invention provides a method and system for monitoring and/or controlling communication signals using computer software and/or hardware. Merely by way of example, the invention is applied to a MEMS based switching system over a wide area network for long haul communications. But it would be recognized that the invention could also be applied to other types of switching such as wave guides, electro-optic devices, holographic switches, bubble switches, liquid crystal switches, and many others, for applications including metropolitan, access, and other networks.

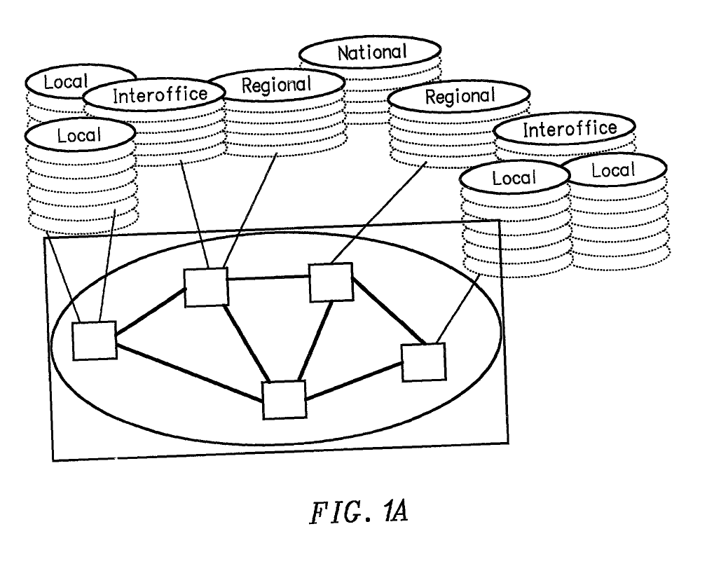

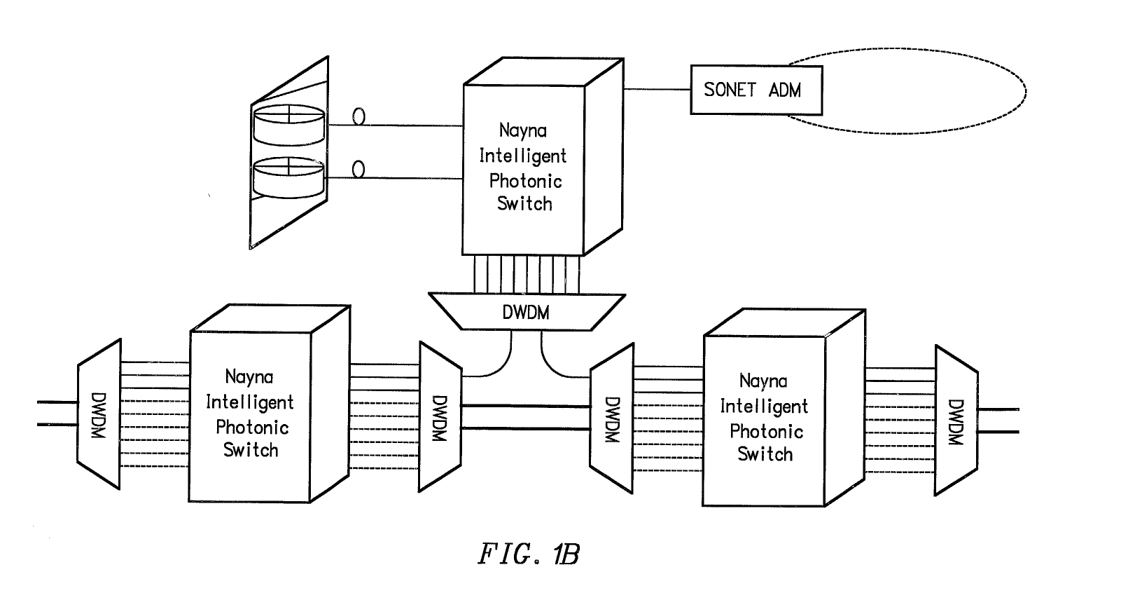

FIG. 1 is simplified diagram 100 of an optical switching network according to an embodiment of the present invention. This diagram is merely an example, which should not unduly limit the scope of the claims herein. One of ordinary skill in the art would recognize many other variations, modifications, and alternatives. As shown, the diagram illustrates an optical network system 100 including a plurality of SONET rings or the like, which are shown by a cloud 101 configuration. Each of the SONET rings is coupled to one or more network switching systems 103, 105, which are coupled to each other. The network switching systems can be coupled to long haul optical network system. In a specific embodiment, each of the systems switches an optical signal from one of the rings to another one of the rings, where the transmission path is substantially optical. That is, the signal is not converted into an electrical signal via an optoelectronic device, which is coupled to an electrical switch that switches the signal. In the present embodiment, the transmission path is substantially optical. Further details of the switching system are provided below.

In a specific embodiment, the invention provides a system for bypassing traffic from the SONET networks, which can be congested, onto optical networks, as shown in FIG. 1A. The traffic from the congested SONET rings from regional, national, local, interoffice, and others will be tapped off and transported across the country to the destination. The switches can be deployed at major hubs to add, drop, and transport traffic through the network. Shown below are typical examples of how the present switches may be configured to relieve the SONET traffic.

A reference model has been provided for the deployment of optical switches as shown in FIG. 1B. The present system can be coupled to nodes with DWDM terminating equipment. The system supports connection from remote and collocated routers as well as, for example, SONET ADMs. Although the above has been described in terms of specific system hardware features, it would be recognized that there could be many alternatives, variations, and modifications. For example, any of the above elements can be separated or combined. Alternatively, some of the elements can be implemented in software or a combination of hardware and software. Alternatively, the above elements can be further integrated in hardware or software or hardware and software or the like. The present system can also be deployed in other configurations, as well. It is also understood that the examples and embodiments described herein are for illustrative purposes only and that various modifications or changes in light thereof will be suggested to persons skilled in the art and are to be included within the spirit and purview of this application and scope of the appended claims.

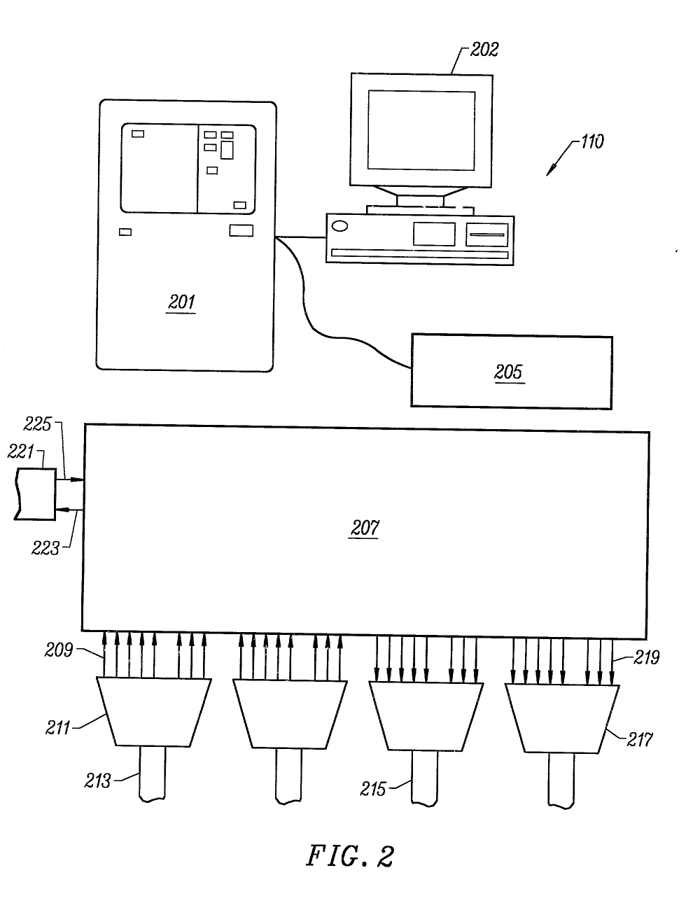

FIG. 2 is a detailed diagram of an optical switching system 110 according to an embodiment of the present invention. This diagram is merely an example, which should not unduly limit the scope of the claims herein. One of ordinary skill in the art would recognize many other variations, modifications, and alternatives. As shown, the switching system 110 includes a variety of features such as a switching apparatus 207. Apparatus 207 couples to incoming fiber 213 through demultiplexer devices 211. In a preferred embodiment, the demultiplexer devices are DWDM devices, which receive signals from incoming fiber 213 and separate such signals into channels 209, each representing a wavelength or the like. Apparatus 207 also couples to outgoing fiber 215 through multiplexer devices 217. In a preferred embodiment, the multiplexer devices are DWDM devices, which receive channels representing wavelengths 219 from the apparatus and output such channels as outgoing optical signals. Client device 221, such as for example a router, couples to apparatus 207 through interfaces 223 and 225.

A communication control device 205 couples to the apparatus. Such control device is overseen by a computing device 201, which includes a display. The computing device can be any suitable microprocessor based device. The computing device couples to display 202. Depending upon the embodiment, a variety of software processes can be incorporated into the computing device, which have been described throughout the present specification and more particularly below. Additionally, further details of the apparatus are also provided throughout the present specification and more particularly below.

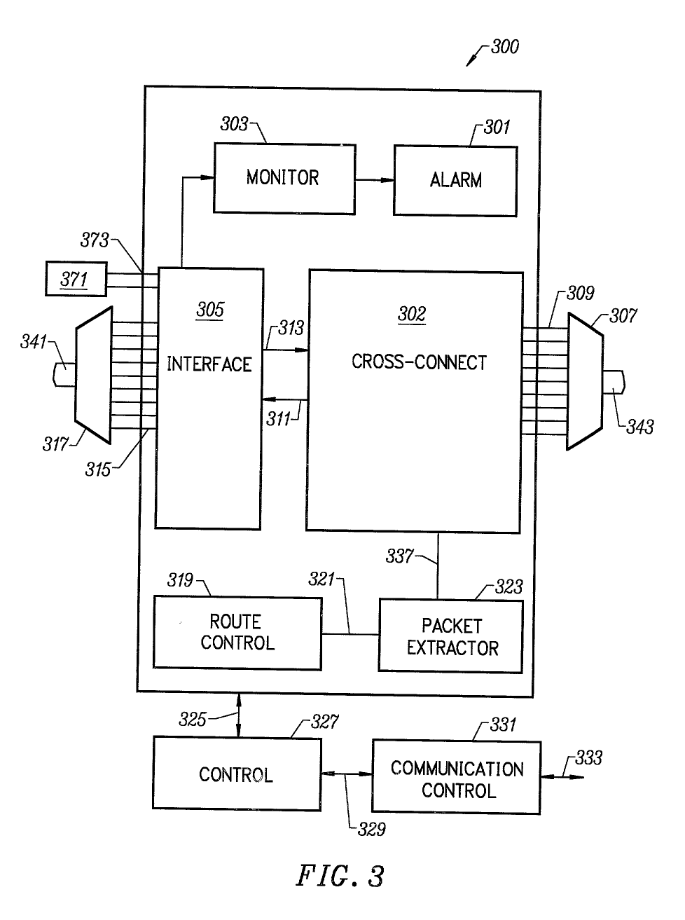

FIG. 3 is a more detailed diagram of an optical switching system 300 according to an embodiment of the present invention. This diagram is merely an example, which should not unduly limit the scope of the claims herein. One of ordinary skill in the art would recognize many other variations, modifications, and alternatives. As shown, the system has a variety of elements including fiber interfaces, 305, which couple to cross-connect 302. Fiber interfaces 305 couple to multiplexers/demultiplexers, DWDM devices, 317, 307; and client device 371 with interface 373. Device 317 has input fiber 341 and output fibers 315, which are numbered from 1 to n, representing integers for example. Device 307 has output fiber 343 and output fibers 309, which are numbered from 1 to n. The data path through the interface devices and cross-connect correspond to light paths through the fiber interfaces, and the switching matrices. In a specific embodiment, the paths are switched at configuration through user control or dynamically through multi-protocol latched switching (MPLS) signaling messages. In preferred embodiments, generally all data paths through the system have redundant configurations to support high system availability and avoid single points of failure.

Other elements include a performance monitoring module 303 coupled to the interface and an alarm 301 coupled to the module. Additionally, the system includes a packet extractor 323 coupled to the cross-connect 302 via line 337. A route control 319 is coupled to the packet extractor via line 321. Overseeing and controlling the system is control 327 coupled via line 325. Communication control 331 is coupled to control via line 329. The communication control 331 couples to network management modules via network interface 333. Further details of networking and other interface devices are provided below.

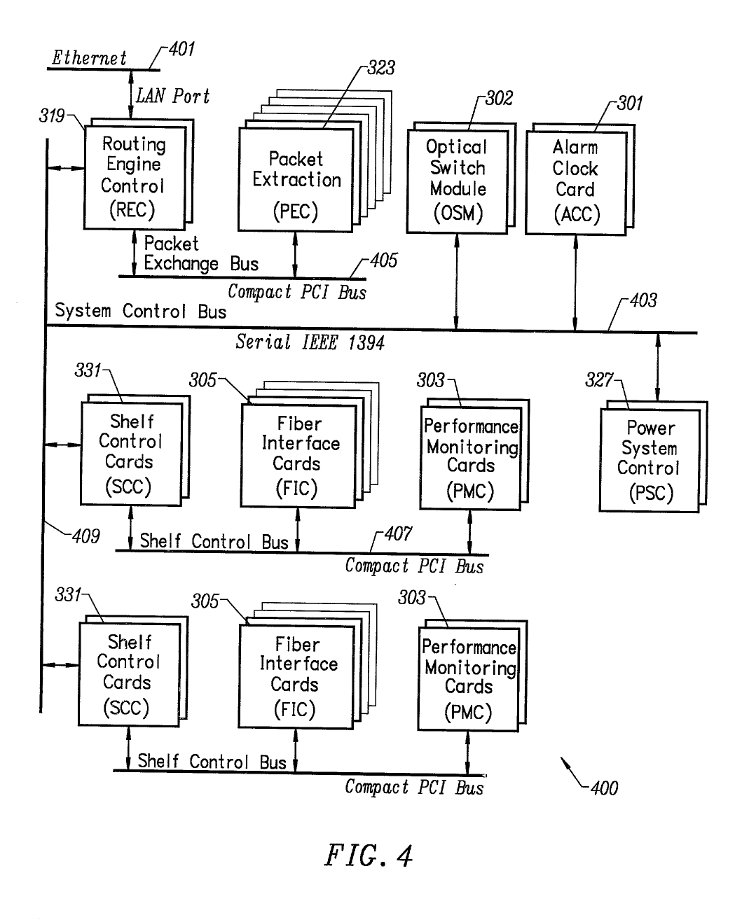

FIG. 4 is a more detailed block diagram 400 of an optical switching system according to an alternative embodiment of the present invention. This diagram is merely an example, which should not unduly limit the scope of the claims herein. One of ordinary skill in the art would recognize many other variations, modifications, and alternatives. Like reference numerals are used in this Fig. as the previous Fig. for cross-referencing purposes only. As shown, the system includes interface devices, such as a local area network 401, which couples to the routing engine control 319. The system also includes a common system control bus 403, which couples to optical switch module 302 and alarm clock card 301. The control bus also couples to power system control 327. The system control bus also couples to shelf control card, which couples to fiber interface card 305 and couples to performance monitoring card 303 through shelf control bus 407. The system control bus 409 couples to shelf control card, which also couples to fiber interface card 305 and performance monitoring card 303 through shelf control bus.

Although the above has been described in terms of specific system hardware features, it would be recognized that there could be many alternatives, variations, and modifications. For example, any of the above elements can be separated or combined. Alternatively, some of the elements can be implemented in software or a combination of hardware and software. Alternatively, the above elements can be further integrated in hardware or software or hardware and software or the like. Further details of each of the elements in this diagram are provided throughout the specification and more particularly below.

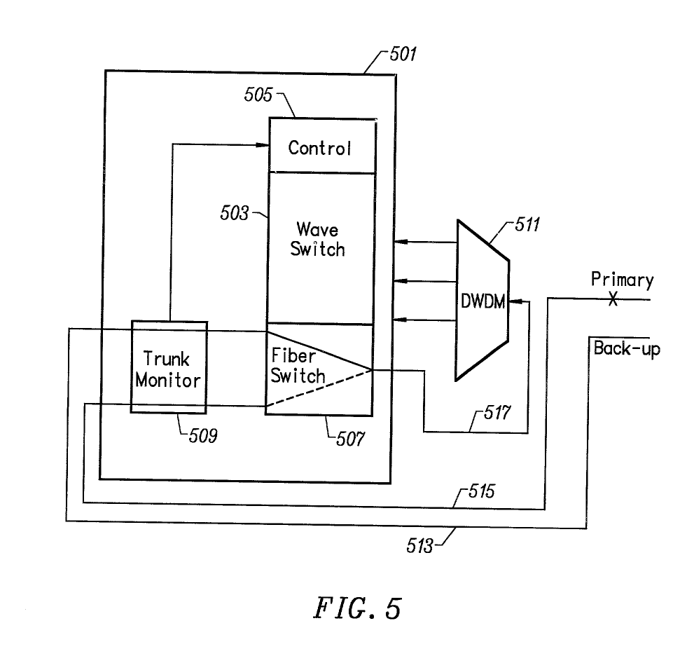

FIG. 5 is a simplified diagram of a system 501 according an embodiment of the present invention. This diagram is merely an example and should not unduly limit the scope of the claims herein. One of ordinary skill in the art would recognize many other variations, modifications, and alternatives. The present system has been modified for monitoring defects such as fiber cuts before the system. As shown, the system has a central switch 503. The switch can be a number of optical switches such as the one noted above but can also be others. The switch is coupled to a control module 505. The control module can be outside of the switch or within the switch. The system also has a fiber switch 507. The fiber switch can select between more than one fiber, such as a primary fiber 515 or a back up fiber 513, as well as other fibers. Coupled between the fiber switch and fibers 513, 515 is trunk monitoring device 509. A multiplexing device 511 sits between the fiber switch and optical switch 503. The multiplexing device can include a DWDM device, as well as others.

In a specific embodiment, the present system includes the trunk-monitoring device on the trunk side of the DWDM device. In some embodiments, the trunk-monitoring device is optional. In the present embodiment, however, the trunk-monitoring device is preferred. The trunk monitoring device can detect a number of detects such as power failure, other optical limitations. The trunk monitoring device communicates with control 505 through a network such as Fast or Gigabit Ethernet. Of course, one of ordinary skill in the art would recognize many variations, modifications, and alternatives.

The present system can monitor incoming fibers for a fiber cut in some embodiments. When a fiber has been cut, the trunk-monitoring device identifies the cut by detecting a loss in signal. Once the cut has been identified, the device switches the fiber from the primary to the backup fiber (rather than switching individual wavelengths). Here, the control device switches the signal from the primary to the back up fiber at the incoming fiber location.

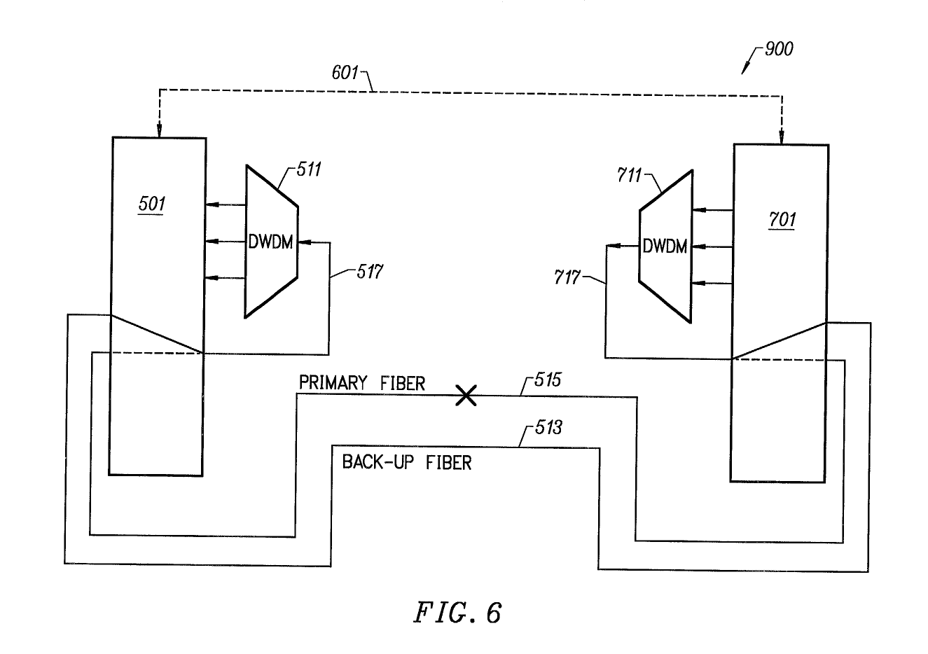

The control device also directs switching the signal from the primary to the backup fiber at the originating signal location for the primary fiber as illustrated by FIG. 6. Like reference numerals are used in this Fig. as the previous Fig. for cross-referencing purpose only. FIG. 6 shows a portion of the network 900 comprising switching systems 501 and 701. Coupled to 501 is a DWDM device 511 and fiber 517, and coupled to 701 is a DWDM device 711 and fiber 717. When the fault in the primary fiber 515 is detected at 501 it signals 701 through communication channel 601 to switch over to back-up fiber 513. 601 can be realized through a network such as Fast or Gigabit Ethernet. Of course, one of ordinary skill in the art would recognize many variations, modifications, and alternatives.

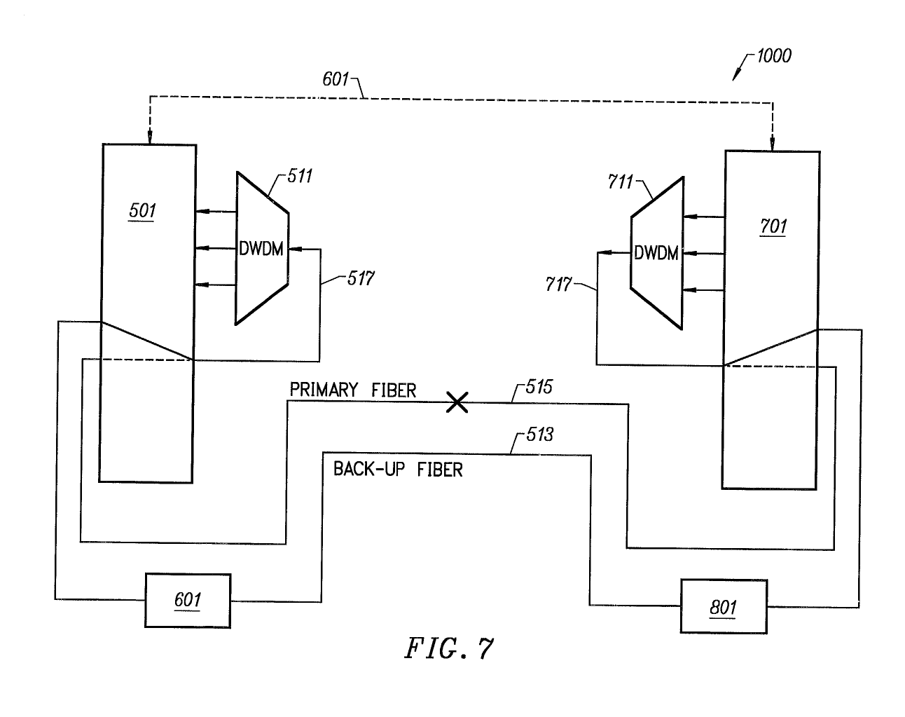

Yet another embodiment of the invention is shown in FIG. 7. In this Fig., a portion of the network 1000 is shown for illustrative purposes only. Like reference numerals are used in this Fig. as the previous Fig. for cross-referencing purpose only. FIG. 7 is similar to FIG. 6 with the exception that the back-up fiber 513 passes through systems 601 and 801. Systems 501, 601, 701, and 801 are all intelligent photonic switching systems. In this embodiment of the invention, the outage of the primary fiber is restored through back-up fiber that may traverse through one or more intermediate switching systems. Although the primary and the backup fibers are shown in terms of direct connections between switching devices, there can be a variety of switches that such fibers couple to in between. That is, multiple switches can be deployed between any of the fibers. Of course, one of ordinary skill in the art would recognize many variations, modifications, and alternatives.

In yet another embodiment of the invention, although not shown here for the sake of brevity, the primary fiber may traverse through one or more intermediate switching systems.

In an embodiment of the invention, the back-up fiber is pre-designated for the primary fiber.

In yet another embodiment of the invention, he back-up fiber is designated from a pool of such fibers after the fault has been detected in the primary fiber.

In one embodiment of the invention, the back-up fiber is solely reserved for reservation.

In yet another embodiment of the invention, the back-up fiber is permitted to carry pre-emptable traffic.

By way of switching the fiber from the primary to the back up, the signals are routed from the primary to the backup, which allows for communication to continue.

A method according to the present invention can be outlined below.

1. Connect an optical signal from a source to a large fabric switching device in a first optical path;

2. Monitor optical communication signal in the first optical path on the trunk side of the switching device;

3. If the signal is not detected, or has impaired, verify the fault.

4. Send fiber fault control signal to a controller, which is used to oversee truck side signals;

5. Initiate switching program for fiber fault using the controller;

6. If the back-up fiber is not preassigned for restoration then find it from the pool; and if the back-up fiber carries preempt able traffic, then disconnect preemptable connections;

7. Transfer control signal from controller to a switch at the source and a switch at the switching device, which can transfer the signal from the first optical path to a second optical path;

8. Switch the signal from the first optical path to the second or backup optical path;

9. Inform other applicable switches to switch to the back-up path;

10. Monitor the signal in the second optical path;

11. Repair the first optical path; and

12. Perform other steps, as desired.

The above sequence of steps provides a method for monitoring and switching signals from a primary to a backup fiber. Such steps allow for such switching operation to occur before the DWDM device, which has advantages A benefit of the invention is that it enables the intelligent photonic switch to detect fiber defects without resorting to first converting the optical signal to an electrical form. Another advantage of the invention is that it does not have to rely upon DWDM devices to inform the intelligent photonic switches of the existence of the fault on a fiber. Yet another advantage of the invention is that it makes possible realization of more efficient fiber topologies as backup for restoration. Depending upon the embodiment, one or more of these benefits may be achieved. These and other aspects of the present method are described throughout the present specification and more particularly below.

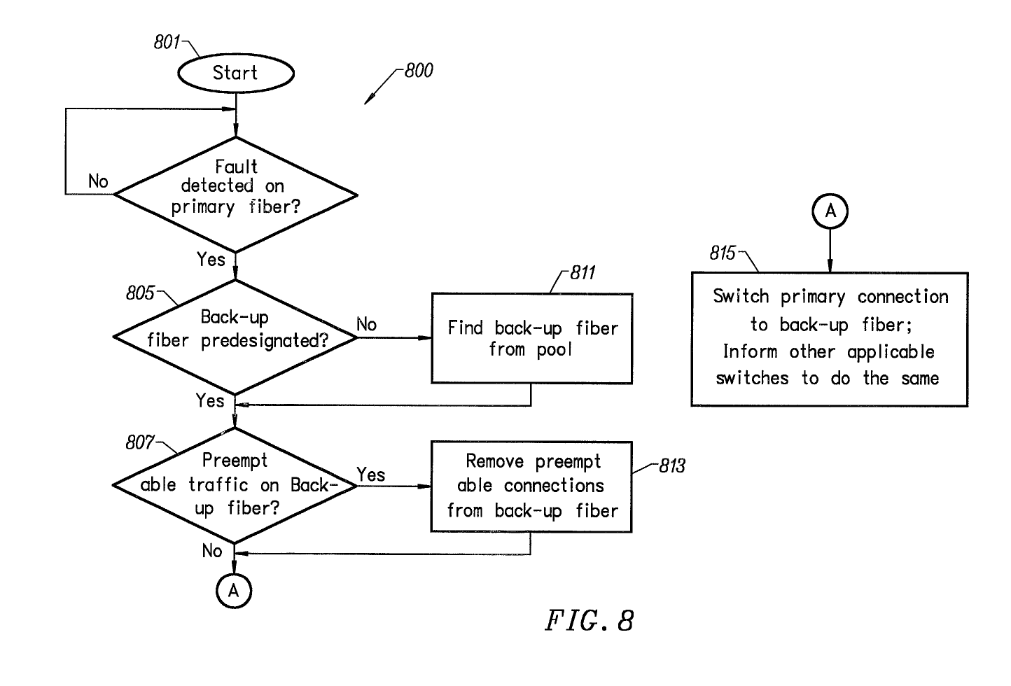

FIG. 8 is a simplified flow diagram 800 of a method according to an embodiment of the present invention. This diagram is merely an example and should not unduly limit the scope of the claims herein. One of ordinary skill in the art would recognize many other variations, modifications, and alternatives. As shown, the method begins at start, step 801. The method connects an optical signal from a source to a large fabric switching device using a first optical path. The method then monitors an optical communication signal in the first optical path on the trunk side of the switching device. If the signal is not detected (step 803), or has impaired, the method verifies the fault. There are a variety of ways of detecting the fault. Here, the method can detect a loss of power, degradation of quality of signal, or other quantitative factors. More particularly, a portion of the signal is tapped in a non-intrusive manner using an optical sensing device such as a photo sensor or the like. Alternatively, the method continues to loop back to start. The method sends a fiber fault control signal to a controller, which is used to oversee truck side signals.

Next, the method initiates a switching program for fiber fault using the controller. If the back-up fiber is not pre-assigned for restoration then the method finds it from the pool, step 811. Here, the pre-assigned backup fiber is designated and known by the method prior to the fault. Alternatively, the backup fiber is derived from a pool of potentially available fibers. Here, the method determines which fiber in the pool is most suitable for the backup during a particular time and type of traffic. If the back-up fiber carries pre-emptable traffic (step 807), then the method disconnect pre-emptable connections, step 813. Here, the preemptable traffic is generally defined as a traffic type that is of low priority as compared to the traffic that is being carried by the primary fiber. Such preemptable traffic may be designated prior to the initiation of the present method but can also be designated during any time that is suitable. The method then transfers a control signal from controller to a switch at the source and a switch at the switching device, which can transfer the signal from the first optical path to a second optical path, which is the backup fiber.

The method switches the signal from the first optical path to the second or back-up optical path, step 815. The method also inform other applicable switches to switch to the back-up path. The method also monitors the signal in the second optical path. The first optical path is then repaired. The above sequence of steps is merely an example. Any of these steps can be further combined or separated, depending upon the application. Other steps can also be inserted into, before, or after any of these steps. Of course, one of ordinary skill in the art would recognize many variations, alternatives, and modifications.

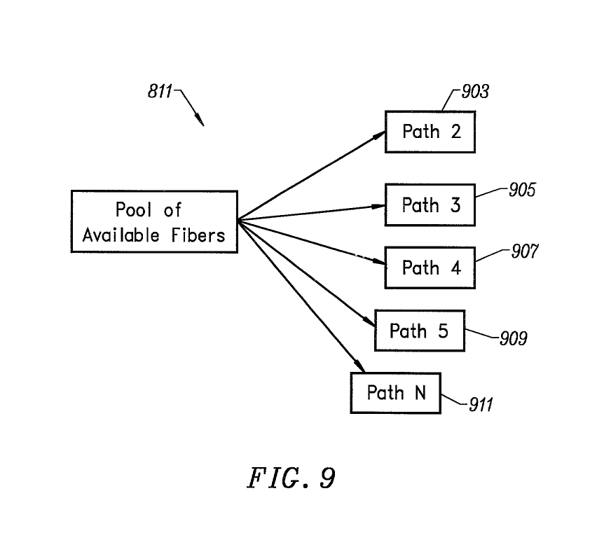

FIG. 9 is a more detailed diagram of the method of FIG. 8 according to an embodiment of the present invention. This diagram is merely an example and should not unduly limit the scope of the claims herein. One of ordinary skill in the art would recognize many other variations, modifications, and alternatives. As shown, the pool of available fibers 811 can include a variety of paths. Some of the paths directly connect one switch to another switch. Other paths go through more than two switches. Alternatively, there can be any number of switches that are used by any path. Any path is basically a way of connecting one switch to another switch. As shown, the pool includes path 2 903, 3 905, 4 907, 5 909, and N 911. Any combination of these may be a different path.

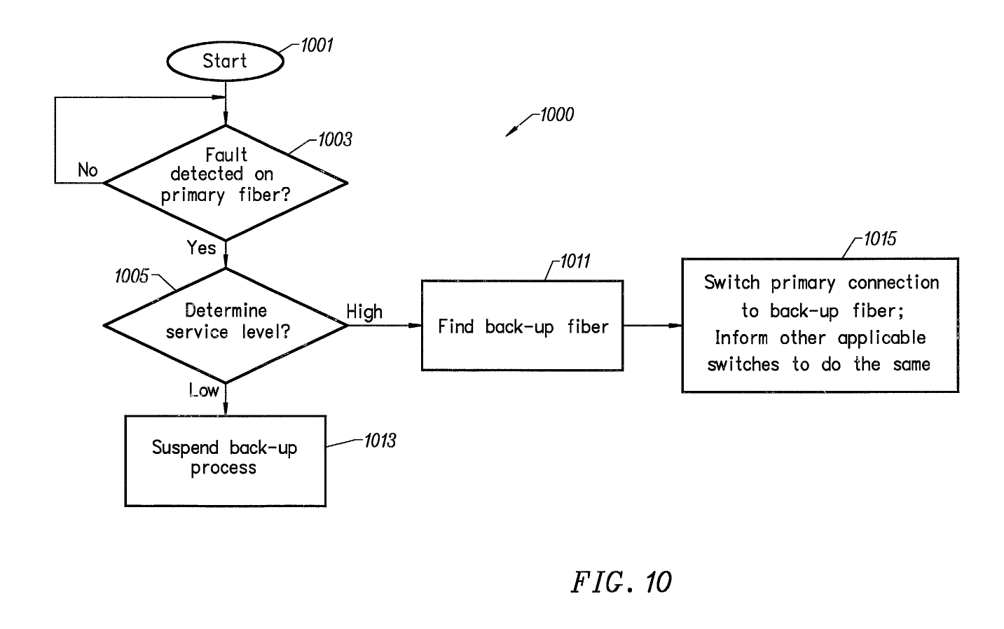

FIG. 10 is a simplified flow diagram of an alternative method 1000 according to an embodiment of the present invention. This diagram is merely an example and should not unduly limit the scope of the claims herein. One of ordinary skill in the art would recognize many other variations, modifications, and alternatives. As shown, the method begins at start, step 1001. The method connects an optical signal from a source to a large fabric switching device using a first optical path. The method then monitors an optical communication signal in the first optical path on the trunk side of the switching device. If the signal is not detected (step 1003), or has impaired, the method verifies the fault. There are a variety of ways of detecting the fault. Here, the method can detect a loss of power, degradation of quality of signal, or other quantitative factors. More particularly, a portion of the signal is tapped in a non-intrusive manner using an optical sensing device such as a photo sensor or the like. Alternatively, the method continues to loop back to start. The method sends a fiber fault control signal to a controller, which is used to oversee truck side signals.

Next, the method initiates a switching program for fiber fault using the controller. The method determines a service level (step 1005) of the faulty fiber. If the service level requires a back-up fiber, the method finds a back-up fiber, step 1011. The back-up fiber may be pre-assigned. Alternatively, it is from the pool of fibers. Here, the method determines which fiber in the pool is most suitable for the backup during a particular time and type of traffic. If the back-up fiber carries pre-emptable traffic, then the method disconnects pre-emptable connections. Here, the preemptable traffic is generally defined as a traffic type that is of low priority as compared to the traffic that is being carried by the primary fiber. Such preemptable traffic may be designated prior to the initiation of the present method but can also be designated during any time that is suitable. The method then transfers a control signal from controller to a switch at the source and a switch at the switching device, which can transfer the signal from the first optical path to a second optical path, which is the backup fiber.

The method switches the signal from the first optical path to the second or back-up optical path, step 1015. The method also inform other applicable switches to switch to the back-up path. The method also monitors the signal in the second optical path. The first optical path is then repaired. Alternatively, the method determines if the service level does not require a back-up fiber. If not, the method suspends (step 1013) the back-up fiber process. The determination of whether the method requires such a back-up fiber is dependent upon a service level of the fiber or in particular the signals, which are described in more detail below. The above sequence of steps is merely an example. Any of these steps can be further combined or separated, depending upon the application. Other steps can also be inserted into, before, or after any of these steps. Of course, one of ordinary skill in the art would recognize many variations, alternatives, and modifications.

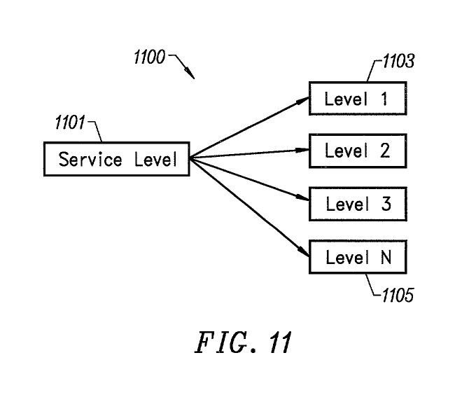

FIG. 11 is a more detailed diagram 1100 of the method of FIG. 10 according to an embodiment of the present invention. This diagram is merely an example and should not unduly limit the scope of the claims herein. One of ordinary skill in the art would recognize many other variations, modifications, and alternatives. As shown, the service level 1101 can include a variety of levels 1 1103, 2, 3 . . . N 1105. Some of the levels would require a back up fiber upon detection of a fault within a pre-determined amount of time, which is often as fast as possible. Others would require a back-up fiber within another pre-determined amount of time. Still other levels would not require a back-up fiber. Any of these levels can be combined or further separated, depending upon the application.

Although the above has been described in terms of specific system hardware features, it would be recognized that there could be many alternatives, variations, and modifications. For example, any of the above elements can be separated or combined. Alternatively, some of the elements can be implemented in software or a combination of hardware and software. Alternatively, the above elements can be further integrated in hardware or software or hardware and software or the like. One of ordinary skill in the art would recognize many variations, modifications, and alternatives.

The system is merely provided to show an example of a way of implementing the present invention. It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An optical switching system for switching one of a plurality of optical signals, the system comprising:
an optical cross-connect apparatus;
a control device coupled to the optical cross-connect apparatus;
a multiplexing device coupled to the optical cross-connect apparatus;
a trunk monitoring device disposed before the multiplexing device, the trunk monitoring device being coupled to at least a first fiber and a second fiber;
a fiber switch coupled between the multiplexing device and the trunk monitoring device, the fiber switch being adapted to switch an optical signal from the first fiber to the second fiber.

2. The system of claim 1 wherein the fiber switch is a two by two switch.

3. The system of claim 1 wherein the multiplexing device is a DWDM device.

4. The system of claim 1 wherein the optical cross-connect apparatus comprises at least an array of 256 mirror devices.

5. The system of claim 1 wherein the fiber switch is positioned after the trunk monitoring device.

6. The system of claim 1 wherein the first fiber is a primary fiber and the second fiber is a back up fiber.

7. The system of claim 1 wherein the control device couples to the trunk monitoring device.

8. The system of claim 1 wherein the control device couples to the fiber switch.

9. The system of claim 1 wherein the trunk monitoring device monitors defects selected from a fiber cut, a defective fiber, or other signal degrading causes.

10. The system of claim 1 wherein the system is coupled to a second system.

11. A method for monitoring and controlling optical signals through a long haul communication network, the method comprising:
monitoring optical signals from a first optical path on a first fiber using a trunk monitoring device, the trunk monitoring device being disposed before a multiplexing device coupled to an input port of a switching system;
detecting a defect in the optical signals using the trunk monitoring device;
determining if the defect is from a selected defect being monitored;
if the defect is a selected defect, initiating a process to switch the optical signals from the first path in the first fiber to a second path in a second fiber; and
transferring the optical signals from the first path to the second path.

12. The method of claim 11 wherein the selected defect is a fiber cut, a degraded fiber, or other signal degrading causes.

13. The method of claim 11 wherein the transferring is provided by switching the optical signals from the first path to the second path.

14. The method of claim 11 wherein the transferring is provided by a fiber switch coupled to the multiplexing device and the trunk monitoring device.

15. The method of claim 14 wherein the fiber switching is between the fiber switch and the first fiber and the second fiber.

16. A method for monitoring and controlling optical signals through an optical communication network, the method comprising:
monitoring optical signals from a first optical path on a first fiber using a trunk monitoring device, the trunk monitoring device being disposed before a multiplexing device coupled to an input port of a switching system;
detecting a defect in the optical signals using the trunk monitoring device;
determining if the defect is from a selected defect being monitored;
if the defect is a selected defect, initiating a process to switch the optical signals from the first path in the first fiber to a second path in a second fiber;
determining an available path for the second path from a pool of fibers, the pool of fibers having a plurality of optical paths;
selecting one of the available paths for the second path; and
transferring the optical signals from the first path to the second path.

17. The method of claim 16 wherein the selected defect is a fiber cut, a degraded fiber, or other signal degrading causes.

18. The method of claim 16 wherein the transferring is provided by switching the optical signals from the first path to the second path.

19. The method of claim 16 wherein the transferring is provided by a fiber switch coupled to the multiplexing device and the trunk monitoring device.

20. The method of claim 19 wherein the fiber switching is between the fiber switch and the first fiber and the second fiber.

21. A method for monitoring and controlling optical signals through an optical communication network, the method comprising:
monitoring optical signals from a first optical path on a first fiber using a trunk monitoring device, the trunk monitoring device being disposed before a multiplexing device coupled to an input port of a switching system;
detecting a defect in the optical signals using the trunk monitoring device;
determining if the defect is from a selected defect being monitored;
if the defect is a selected defect, initiating a process to switch the optical signals from the first path in the first fiber to a second path in a second fiber based upon predetermined selection criteria;
if the first optical path is for a first service level, suspending the process to switch the optical signals from the first path to the second path;
if the first optical path is for a second service level, transferring the optical signals from the first path to the second path.
